(19) United States
(12) Patent Application Publication
(10) Pub. No.: US 2023/0366662 A1
(43) Pub. Date: Nov. 16, 2023

(54) FISHING HEAD WITH RETRACTABLE BLADES FOR BOWFISHING

(71) Applicant: Justin Bradley Hughey, West Branch, MI (US)

(72) Inventor: Justin Bradley Hughey, West Branch, MI (US)

(21) Appl. No.: 18/197,992

(22) Filed: May 16, 2023

Related U.S. Application Data
(63) Continuation-in-part of application No. 17/839,477, filed on Jun. 14, 2022.
(60) Provisional application No. 63/209,977, filed on Jun. 12, 2021.

(51) Int. Cl. F42B 6/08; A01K 81/00

(52) U.S. Cl. CPC F42B 6/08; A01K 81/00

(57) ABSTRACT

An arrowhead for use with bowfishing includes a body defining a chamber and first and second slots extending from the chamber to the exterior surface of the body. First and second blades are movably mounted to the body for movement between a retracted position and an extended position. In the retracted position, both blades are substantially entirely within the chamber of the body and do not substantially protrude from the exterior surface of the body. One end of the body defines an annular shoulder having a stem protruding therefrom. The stem includes a portion having external threads. The arrowhead also includes a tip member that has a surface surrounding a hole with internal threads. An elastomeric O-ring defines an aperture. The stem extends through the aperture, and the shoulder and surface surrounding the hole compress the O-ring therebetween.

### CROSS-REFERENCE TO RELATED APPLICATION

This application is a continuation-in-part of U.S. patent application Ser. No. 17/839,477, filed Jun. 14, 2022 and which claims the benefit of U.S. Provisional Patent Application No. 63/209,977, filed Jun. 12, 2021, each of which is hereby incorporated by reference in its entirety.

### TECHNICAL FIELD

The present disclosure is related to a fishing head with retractable blades for bowfishing.

### BACKGROUND

Bowfishing is a type of fishing that uses archery equipment, such as a bow or crossbow, to shoot and recover fish. The fish are shot with a barbed arrow. The barbed arrow is attached with line to a reel that is mounted on a bow or crossbow. Some types of freshwater fish that are shot include carp, grass carp, alligator gar, bighead carp, bowfin, and the like. Bowfishing may also be done in saltwater to shoot rays, sharks, etc.

### SUMMARY

An arrowhead for use with bowfishing includes a body defining a chamber and first and second slots extending from the chamber to the exterior surface of the body. First and second blades are movably mounted to the body for movement between a retracted position and an extended position. In the retracted position, both blades are substantially entirely within the chamber of the body and do not substantially protrude from the exterior surface of the body. In the extended position, the blades protrude from the exterior surface of the body such that they act to retain a fish after the arrowhead has pierced the fish. The arrowhead is configured such that the first and second blades automatically move from their respective retracted position to their respective extended position as a result of impact with a fish.

One end of the body defines an annular shoulder having a stem protruding therefrom. The stem includes a portion having external threads. The arrowhead also includes a tip member that has a surface surrounding a hole with internal threads. The internal threads are engaged with the external threads of the stem to retain the tip member to the body. The tip member defines a sharp tip configured to form the forward end of the arrowhead so that when the arrowhead impacts a target the sharp tip contacts the target first. An elastomeric O-ring defines an aperture. The stem extends through the aperture, and the shoulder and surface surrounding the hole compress the O-ring therebetween.

The arrowhead provided herein improves upon the prior art because the tip member is replaceable, thereby prolonging the life of the body and the mechanism deploying the blades (i.e., when the tip is no longer sharp, a new tip member may be attached to the stem). The O-ring provides backpressure to make the connection of the tip member to the body secure and tight. Furthermore, the O-ring also absorbs shock, which prolongs the life of the nock of the arrow to which the arrowhead is attached.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

Various features of the present invention will become more fully apparent from the following description and appended claims, taken in conjunction with the accompanying drawings. Understanding that these drawings depict only typical embodiments of the invention and are, therefore, not to be considered limiting of its scope, the embodiments of the invention will be described and explained with additional specificity and detail through the use of the accompanying drawings.

FIGS. 1 and 2 are illustrative environmental views of a fisherman bowfishing using a bow with a fishing head on an arrow.

FIG. 3 is a schematic illustrative side perspective view of a fishing head with blades in a retracted position, an intermediate position, and an extended position.

FIG. 4 is another schematic illustrative perspective view of the fishing head with the blades in the extended position.

FIG. 5 is an illustrative exploded perspective view of the fishing head.

FIG. 6 is a schematic perspective view of a blade of the fishing head.

FIG. 7 is a schematic top view of the blade of FIG. 6.

FIG. 8 is a schematic side view of an inner side of the blade.

FIG. 9 is a schematic perspective view of the plunger of the fishing head.

FIG. 10 is a schematic perspective view of a body of the fishing head.

FIG. 11 is a schematic side view of the plunger of the fishing head.

FIG. 12 is a schematic side view of the body of the fishing head.

FIG. 13 is a schematic, side view of a tip member.

FIG. 14 is a schematic, top view of an O-ring.

FIG. 15 is a schematic, sectional, side view of the O-ring.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure. Furthermore, the drawings are in simplified form and are not to precise scale. For purposes of convenience and clarity only, directional terms such as top, bottom, left, right, up, down, upper, lower, upward and downward may be used with respect to the drawings. These and similar directional terms are not to be construed to limit the scope of the disclosure in any manner. Additionally, the disclosure, as illustrated and described herein, may be practiced in the absence of any element that is not specifically disclosed herein.

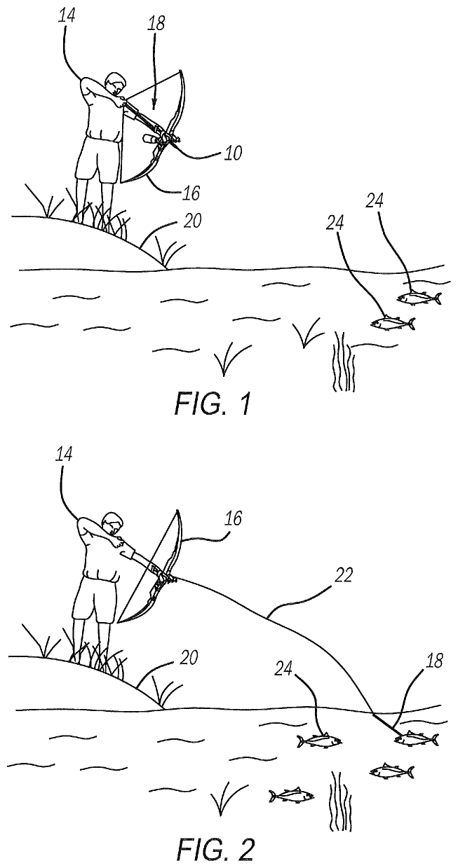

Referring to the drawings, wherein like reference numbers refer to like components throughout the several Figures, FIGS. 1 and 2 are illustrative views of a fishing head 10 of an arrow 18 being used for bowfishing by a fisherman 14. FIG. 1 illustrates the fisherman holding a bow 16 and arrow 18 on a shoreline 20 and aiming for a fish 24. FIG. 2 illustrates the fisherman 14 having shot the fish 24 with the bow 16, where the fishing head 10 of the arrow 18 pierced the fish 24, and the arrow 18 is tethered to the bow 16 via a fishing line 22 or otherwise tethered.

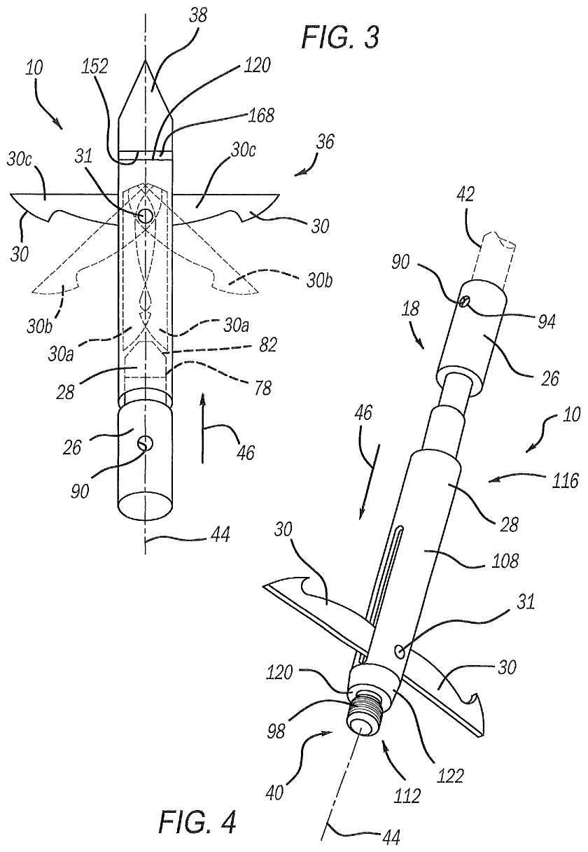

Referring now to FIG. 3, a side perspective view of the fishing head 10 is shown. The fishing head 10 includes a plunger 26, a body 28, and a pair of blades 30. As illustrated by the broken lines, the blades 30 are configured to move from a retracted position, as shown in phantom at 30a, through an intermediate position, as shown in phantom at 30b. The blades 30 eventually extend, or flare out, from the body 28 to an extended position as shown at 30c.

Referring to FIGS. 3-5, the blades 30 may be pivotally attached to the body 28 via a pin 31. The pin 31 is configured to pivotally secure the blades 30 relative to the body, such that the blades 30 pivot about the pin 31, relative to the body 28 to move from the retracted position 30a to the extended position 30c.

With continuing reference to FIG. 1, when bowhunting, the fishing head 10 is assembled with the blades 30 in the retracted position 32, and the plunger 26 at least partially slidably disposed in an end of the body 28. The fishing head 10 is configured such that the plunger 26 moves along an axis 44 (direction is indicated by arrow 46), relative to the body 28, in response to the tip portion 38 of the fishing head 10 impacting the fish 24. More specifically, when the fishing head 10 is propelled, the tip portion 38 impacts the fish 24, a force of the impact causes the plunger 26 to move within, and relative to, the body 28, along the axis 44 until the plunger 26 contacts a ramp portion 68 of each of the blades 30. When the plunger 26 moves along the axis 44, the end portion 48 of the plunger 26 moves further within the body 28 and pushes against the ramp portion 68 to force the blades 30 to pivot about the pin 31, and outward relative to the body 28, from the retracted position to the extended position. Details of this will be explained in more detail below.

A tip portion 38 may be attached to the body 28, opposite the plunger 26. The tip portion 38 may be attached to the body 28 via a threaded attachment 40 (FIG. 4). Referring now to FIG. 4, an arrow 18 is illustrated without a tip portion 38. The arrow 18 includes the fishing head 10 attached to a shaft 42 at the plunger 26.

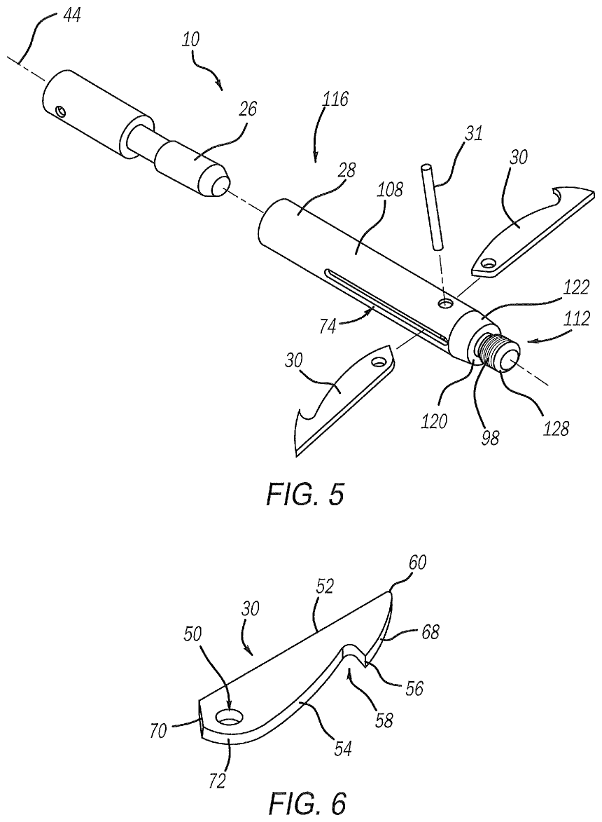

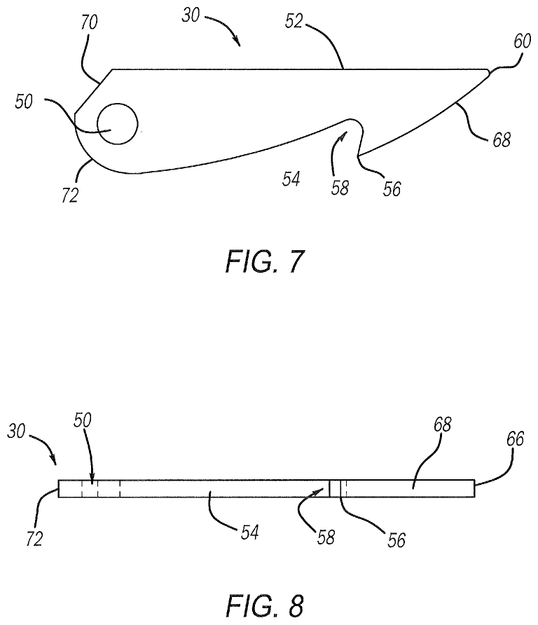

FIG. 5 is a schematic exploded view of the fishing head 10, including the plunger 26, the body 28, the pair of blades 30, and the pin 31. With specific reference to FIGS. 6, 7, and 8, one of the blades 30 is schematically illustrated. Each blade 30 defines a pivot hole 50 configured to receive the pin 31 therein when attached to the body 28. The blade 30 is configured with an outer edge 52 and an inner edge 54, opposite the outer edge 52. When the blade 30 is in the retracted position, the outer edge 52 faces outward from the body 28. The outer edge 52 is configured such that it does not cut the fish. Rather, the outer edge 52 is configured or otherwise shaped to slide directly through the fish 24 when the blades are in the retracted position 32. The inner edge 54 of the blade 30 extends from a tip portion 60 to an end portion 72. The inner edge 54 includes a barb 56 defining a V-shaped notch 58 that faces away from the tip portion 60. When the blades 30 are in the extended position, which is when the fishing head 10 is pushed through the fish 24, the blades 30 are configured such that inner edge 54, including the barb 56 and the inner edge 54 at the V-shaped notch 58, abuts an outside of the fish 24, or otherwise engages flesh within the fish 24, such that the fishing head 10 does not slip back out of the fish.

With reference to FIGS. 3, 11, and 12, the body 28 defines the pair of opposing slots 74, extending therethrough. The blades 30 are pivotally attached to the body 28 such that the blades 30 are recessed within a respective one of the pair of opposing slots 74 when the blades 30 are in the retracted position (30a in FIG. 3) and a portion of the blades 30 extend from the respective slot 74 when the blades 30 are in the extended position (30c in FIG. 3).

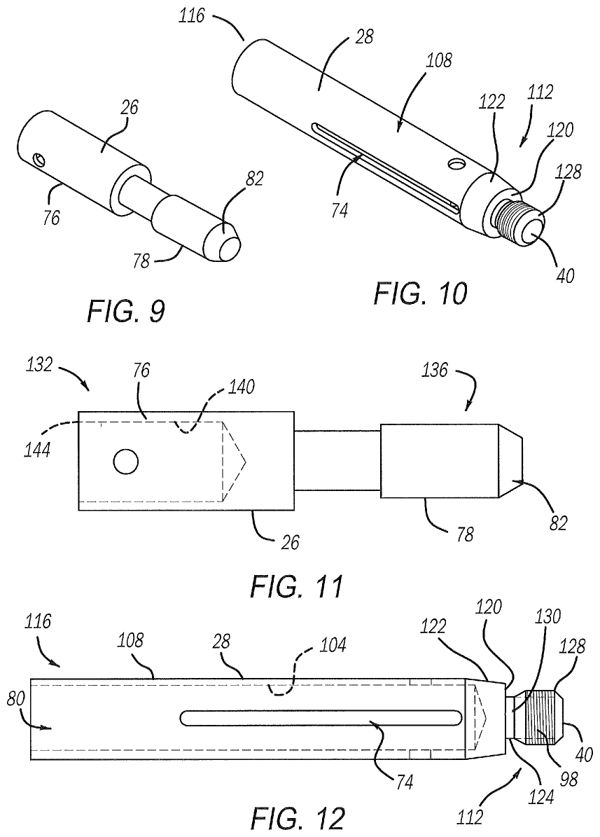

Referring now to FIGS. 9 and 10, the plunger 26 includes a first portion 76 and a second portion 78. The first portion 76 is configured for attachment to the shaft 42 of the arrow 18. The second portion 78 is configured to be received within an opening 80 defined in the body 28. The second portion 78 of the plunger 26 may present an end portion 82 having a frustoconical shape, i.e., a ramped end. The end portion 82 is configured to rest against or otherwise abut the ramps 68 of the blades 30 when the blades 30 are retracted, as shown in phantom in FIG. 3. When the load is applied to the plunger 26, along the axis 44, the plunger 26 moves along the axis 44, relative to the body 28, such that the end portion 82 of the plunger 26 acts on the ramps 68 to force the blades 30 to flare out from the closed position 32 to the extended position 36. Ramps 68 are curved surfaces or edges. In the embodiment depicted, the ramps are arcuate.

As long as the plunger 26 maintains its position along the axis 44, within the body 28, the blades 30 will remain in the extended position 36 because the barbs 56 and the V-shaped notch 58 are flared beyond the slots 74, such that the V-shaped notches 58 of the blades 30 engage the body of the fish to prevent the blades 30 from moving from the extended position 36 back toward the retracted position 32.

Accordingly, the fishing head, or arrowhead 10, includes a body 28 that defines a first chamber 104 and two slots 74 extending from the first chamber 104 to the exterior surface 108 of the body 28. In the embodiment depicted, the exterior surface 108 is substantially cylindrical, but may have other geometries within the scope of the claimed invention. For example, the exterior surface 108 may be frustoconical so that the diameter lessens with proximity to attachment 40. Similarly, the chamber 104, and the inner surface defining chamber 104, is substantially cylindrical.

The arrowhead 10 also includes first and second blades 30 that are pivotably connected to the body 28 via pin 31 such that the first and second blades 30 are moveable between retracted positions, as shown in phantom at 30a in FIG. 3, and extended positions, as shown at 30c in FIG. 3. The first and second blades 30 are entirely disposed within the first chamber 104 when the first and second blades 30 are in their respective retracted positions, and the first and second blades 30 protrude from the exterior surface 108 of the body 28 through a respective slot 74 when the first and second blades 30 are in their respective extended positions. In the embodiment depicted, the blades rotate 90 degrees from their retracted positions to their extended positions. It should be noted that, as used herein, the first and second blades 30 being “entirely within the first chamber 104” includes the blades 30 extending partially into the slots 74 but not extending past the outer surface 108.

The body 28 has a first end 112 and a second end 116. The first end 112 defines an annular shoulder 120 that extends radially relative to the axis 44 and that faces axially away from the second end 116. In one embodiment, the exterior surface 108 may have a tapered section 122 of reducing diameter adjacent to the shoulder 120. The attachment segment 40 includes a cylindrical stem 124 protruding from the center of the shoulder 120 along the axis 44. Cylindrical stem 124 includes a segment 128 defining external helical threads 98. In the embodiment shown, the stem 124 also includes a segment 130 having a smaller diameter than segment 128.

The body 28 defines a first opening 80 to the first chamber 104 at the second end 116. The plunger member 26 has a third end 132 and a fourth end 136. The plunger member 26 defines a second chamber 140 having a second opening 144 at the third end 132. The second chamber 140 is configured to receive the 42 shaft of an arrow through the through the opening 144. The plunger member 26 defines a hole 90 that extends from the exterior surface of the plunger member 26 to the second chamber 140 such that the shaft 42 is retained within the chamber 140 with a pin (as shown at 94 in FIG. 4) that extends through the hole 90.

The end 136 of the plunger member 26 is positioned within the first chamber 104. When the blades 30 are in their retracted positions, end 82 abuts the ramp portions 68 as shown in FIG. 3. Ramp portions 68 and the beveled or tapered end 82 are configured such that movement of the plunger member 26 against the blades 30 imparts a lateral movement on the blades 30, thereby causing the blades 30 to rotate about the pin 31 from the retracted position to the extended position.

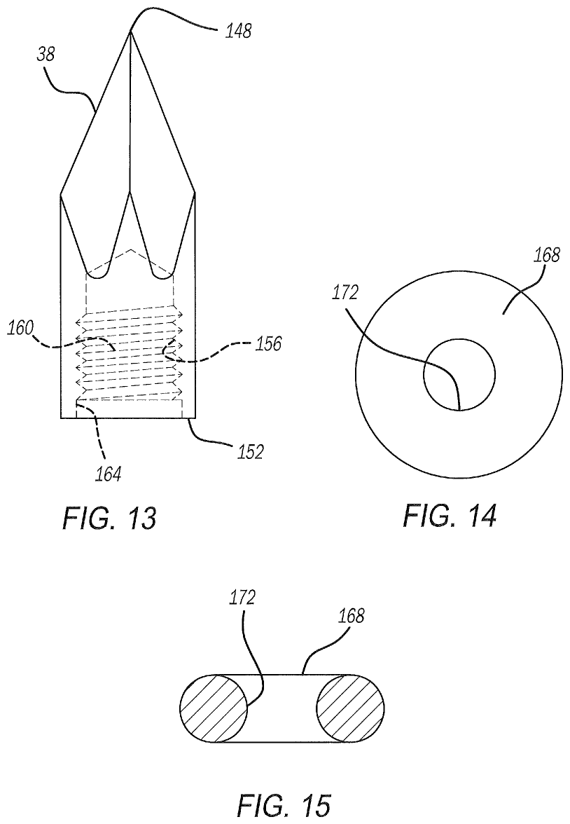

Referring to FIG. 13, wherein like reference numbers refer to like components from FIGS. 1-12, the tip member 38 defines a sharp tip 148 at one end, and a surface 152 at the other end. The tip member 38 defines a hole 156 with internal threads 160 having an opening 164. The opening 164 is surrounded by annular surface 152.

Referring to FIGS. 14 and 15, wherein like reference numbers refer to like components from FIGS. 1-13, an O-ring 168 is schematically depicted. The O-ring 168 defines a central aperture 172. In the embodiment depicted, the outer diameter of the O-ring 168 is 6 millimeters, the inner diameter of the O-ring 168 is 2 millimeters, and the thickness of the O-ring 168 is 2 millimeters. The O-ring 168 is comprised of an elastomeric material such as nitrile rubber.

As shown in FIG. 3, the O-ring 168 is attached to the body 28 by placing the O-ring 168 against the shoulder 120 with the stem 124 extending through the aperture 172. Segment 128 of the stem 124 is then inserted into the hole 156 of the tip member 38 through the opening 164. With the segment 128 in hole 156, the tip member 38 is rotated about axis 44 relative to the body 28 so that the internal threads 160 and the external threads 98 engage with each other. Surface 152 will draw closer to shoulder 120 until the surface 152 and the shoulder 120 contact opposite sides of the O-ring 168 and compress the O-ring 168 therebetween.

The blades 30 in the embodiment depicted are comprised of 304 stainless steel, and are formed by milling on a CNC milling machine, which results in improved blade performance compared to stamping.

While the best modes for carrying out the disclosure have been described in detail, those familiar with the art to which this disclosure relates will recognize various alternative designs and embodiments for practicing the disclosure within the scope of the appended claims.

1. An arrowhead for use with bowfishing comprising:
a body defining a chamber and first and second slots extending from the chamber to the exterior surface of the body;
first and second blades being movably mounted to the body for movement between a respective retracted position and a respective extended position;
wherein both blades are substantially entirely within the chamber of the body and do not substantially protrude from the exterior surface of the body in their respective retracted position;
wherein both blades protrude from the exterior surface in their respective extended position;
wherein the arrowhead is configured such that the first and second blades automatically move from their respective retracted position to their respective extended position as a result of the arrowhead impacting a fish;
wherein the body defines an annular shoulder having a stem protruding therefrom, said stem having external threads;
a tip member that has a surface surrounding a hole with internal threads that are engaged with the external threads;
an elastomeric O-ring defining an aperture;
said O-ring being compressed between the shoulder and the surface of the tip member.

2. The arrowhead of claim 1, further comprising a plunger member being attachable to a shaft of an arrow, the plunger member extending into the chamber;
wherein the blades and the plunger are configured such that movement of the plunger relative to the body and toward the tip member causes the blades to move from their retracted positions toward their extended positions.

3. The arrowhead of claim 2, wherein the blades define arcuate surfaces that contact the plunger when the blades are in their respective retracted position.

4. The arrowhead of claim 3, wherein the blades comprise 304 stainless steel.

5. The arrowhead of claim 4, wherein the blades are formed by milling on a CNC milling machine.
